(19) United States
(12) Patent Application Publication
(10) Pub. No.: US 2026/0100616 A1
(43) Pub. Date: Apr. 9, 2026

(54) WHEEL AXIAL FLUX YOKELESS OUTRUNNER ELECTRIC MOTOR PROVIDING CABLES AND COOLING INTERNALLY

(71) Applicant: Yuriy Radzikh, Willow Grove, PA (US)

(72) Inventor: Yuriy Radzikh, Willow Grove, PA (US)

(21) Appl. No.: 19/234,168

(22) Filed: Jun. 10, 2025

Related U.S. Application Data
(63) Continuation-in-part of application No. 17/861,145, filed on Jul. 8, 2022, now Pat. No. 12,328,044.
(60) Provisional application No. 63/219,713, filed on Jul. 8, 2021.

(51) Int. Cl. H02K 1/2798; H02K 1/18; H02K 7/00; H02K 7/08

(52) U.S. Cl. CPC H02K 1/2798; H02K 1/182; H02K 7/006; H02K 7/083

(57) ABSTRACT

An electric motor including a stator (having coils) between first and second rotors (having magnets). The stator includes a centrally located hollow protrusion extending therefrom. The hollow protrusion is to provide cables and cooling to the stator and to receive a shaft. The motor is mounted in each wheel assembly of an electric automobile so that each wheel thereof is controlled by its own motor. A hub is coupled external to the first rotor and rotates with rotation of the rotors. The hub includes a plurality of bolts extending therefrom to mount a rim thereto by placing the bolts through aligned holes in the rim. The hub is mounted to the shaft and rotation of the hub also causes the shaft to rotate. The shaft is provided to a generator where rotation thereof causes rotation of rotors to generate electricity.

### PRIORITY

This application is a continuation in part (CIP) of and claims the priority under 35 USC § 120 of U.S. Utility Application Ser. No. 17/861,145 filed on Jul. 8, 2022 (issued as U.S. Pat. No. 12,328,044 on Jun. 10, 2025). Utility Application Ser. No. 17/861,145 claims the benefit under 35 USC § 119 of U.S. Provisional Application 63/219,713 filed on Jul. 8, 2021. Application Ser. Nos. 17/861,145 and 63/219,713 are herein incorporated by reference in their entirety.

### BACKGROUND

Electric vehicles (e.g., automobiles) are becoming more popular as they provide a cleaner alternative to gas vehicles. Electric vehicles utilize one or more electric motors to convert electrical energy into mechanical energy and the mechanical energy is utilized to move the vehicles. A typical electric motor includes a stationary component (called a stator) that includes a plurality of coils and a rotating component (called a rotor) that includes a plurality of magnets. When activated the coils create a magnetic field and the magnetic field and the magnets repel or attract each other in a sequence that causes the rotors to spin and create torque.

FIG. 1 illustrates an example radial flux electric motor 100. The motor 100 includes a rotor 110 mounted to a shaft 120. The rotor 110 includes a plurality of magnets 130 mounted on an exterior perimeter thereof. The polarity of the magnets 130 alternates (alternating polarities identified by different color magnets). A stator 140 surrounds the rotor 110 and has a plurality of teeth having coils wrapped therearound (teeth and coils not visible) located on an inner perimeter thereof. The coils and magnets 130 are radially located around the shaft 120 (axis) of the motor 100. As the rotor 110 turns within the stator 140, flux 150 is transmitted from a magnet 130 having a first polarity to the stator 140 every time the magnet 130 sweeps past a coil. The stator 140 provides a return path for the flux 160 to a magnet 130 having an opposite polarity every time the magnet 130 sweeps past a coil. So, the path of the flux 150, 160 is perpendicular to the axis (shaft 120) of the motor 100 in that it goes from the rotor 110 outward to the stator 140, and then returns inward from the stator 140 to the rotor 110.

FIG. 2 illustrates an example axial flux electric motor 200. The motor 200 includes a rotor 210 and a pair of stators 220 (only back stator 220 is illustrated) mounted on a shaft 230. The rotor 210 includes a plurality of magnets 240 mounted on one the sides thereof. The polarity of the magnets 240 alternates (alternating polarities identified by different color magnets). The stators 220 include a plurality of coils (not visible) formed on one side thereof. The coils and magnets 240 are axially located around the shaft 230 (axis) of the motor 200 (are parallel to the shaft 230). As the rotor 210 turns, flux 250 is transmitted from a magnet 240 having a first polarity to the stator 220 every time the magnet 240 sweeps past a coil. The stator 220 provides a return path for the flux 260 to a magnet 240 having an opposite polarity every time the magnet 240 sweeps past a coil. So, the path of the flux 250, 260 is parallel to the axis (shaft 230) of the motor 200.

FIG. 3 illustrates a cross-sectional view of an example axial flux electric motor 300. The motor 300 includes a rotor 310 located between a pair of stators 330. The rotor 310 includes a plurality of magnets 320 on each side thereof. The polarity of the magnets 320 on each side of the rotor 310 alternates. Additionally, magnets 320 aligned on opposite sides of the rotor 310 have opposite polarities. Each of the stators 330 include a plurality of teeth 340 on an interior surface thereof and coils 350 are wrapped around each of the teeth 340. As the rotor 310 turns, flux 360 is transmitted from a magnet 320 having a first polarity (north as illustrated) to a coil 350 on the stator 330 every time the magnet 320 sweeps past a coil 350. The stators 330 provide a return path for the flux 360 from a next coil 350 to a magnet 320 having an opposite polarity (south as illustrated) every time the magnet 320 sweeps past a coil 350. The flux 360 is illustrated as flowing from a first coil 350 on an upper stator 330 through opposite pole magnets 320 (south to north) on the rotor 310 to an aligned coil 350 on a lower stator 330. The lower stator 330 provides a return path for the flux 360 so the flux 360 flows from a second coil 350 on the lower stator 330 through opposite pole magnets 320 (north to south) on the rotor 310 to an aligned coil 350 on the upper stator 330. The stators 330 function as the housing (yoke) for the motor 300.

FIG. 4 illustrates a cross-sectional view of an example yokeless axial flux electric motor 400. The motor 400 includes a stator (not separately identified) located between a pair of rotors 430. As the stator is centrally located it does not function as the housing (thus there is no yoke). The stator includes a plurality of teeth 410 having coils 420 wrapped therearound. The rotors 430 include a plurality of magnets 440 on interior surfaces thereof. The polarity of the magnets 440 on each rotor 430 alternate. Additionally, magnets 440 aligned on opposite rotors 430 have opposite polarities. As the rotors 430 turn, flux 450 is transmitted from a magnet 440 having a first polarity (south as illustrated) to a coil 420 on the stator every time the magnet 440 sweeps past a coil 420. The flux 450 flows from the coil 420 to a magnet 440 having a second polarity (north as illustrated) every time the magnet 440 sweeps past a coil 420. The rotors 430 provide a return path for the flux 450. The flux 450 is illustrated as flowing from a first polarity (south) magnet 440 on an upper rotor 430 through a first coil 420 on the stator to a second polarity (north) magnet 440 on a lower rotor 430. The lower rotor 430 provides a return path for the flux 450 so the flux 450 flows from a first polarity (south) magnet 440 on the lower rotor 430 through a second coil 420 on the stator to a second polarity (north) magnet 440 on the upper rotor 430.

The yokeless axial flux electric motor 400 may include some type of housing so the turning rotors 430 are covered. However, the housing utilized is thinner and lighter than utilizing the stator as the housing (yoke). Accordingly, the yokeless axial flux electric motors 400 are much lighter and thinner than the radial flux motors. Furthermore, they operate more efficiently and have a higher power density. However, as the coils 420 are centrally located and a yoke is not utilized as a heat sink, issues associated with these motors include providing electrical cables to the coils and providing cooling thereto.

FIG. 5 illustrates a cross-sectional view of an example axial flux yokeless motor 500. The motor 500 includes a stator 510 and a pair of rotors 520 mounted on a shaft 530. The stator 510 is centrally located and includes bearings 515 that contact the shaft 530 so that the shaft 530 can rotate within the stator 510 while the stator 510 remains stationary. The rotors 520 are located on each side of the stator 510 and are secured to the shaft 530 so that when they rotate, they also rotate the shaft 530. The stator 510 includes windings 540, and the rotors 520 include magnets 550 facing the stator 510. The polarity of the magnets 550 alternates on each rotor 520 and also between each rotor 520.

The stator 510 may be larger than the rotors 520 and include a circular exterior 560 casing around a perimeter thereof (illustrated as top and bottom in cross sectional view). Sidewalls 570 may be located external to the rotors 520 to seal the motor 500. The sidewalls 570 include bearings 575 that contact the shaft 530 so that the shaft 530 can rotate therewithin while the sidewalls 570 remain stationary. The sidewalls 570 may be secured to the stator casing 560. The power and cooling may be provided to the motor 500 via one or more channels 580 located external to the stator casing 560. The motor 500 is referred to as an inrunner motor since the rotors 520 are protected by the casing 560 and the sidewalls 570. Accordingly, the shaft 530 is rotated by the rotors 520 and the shaft 530 is utilized to provide the mechanical energy.

FIG. 6 illustrates an electric automobile 600 utilizing an inrunner axial flux yokeless electric motor (e.g., 500 from FIG. 5). The motor 500 is mounted on a shaft 610 and causes the shaft 610 to spin. The spinning shaft 610 is then utilized to provide mechanical energy (torque, rotation) to one or more axels 620. A gear box 630 may be utilized to convert the speed of the shaft 610 to the desired speed of an axel 620. The axels 620 are connected to a hub 640 that enable rim 650 and wheel (tire) 660 to be mounted thereto. The hub 640 includes bolts 670 extending therefrom that align with holes (not illustrated) in the rim 650. The rim 650 is secured in place with lug nuts (not illustrated). The speed and direction of the rotation of the axels 620 cause the automobile to move in the desired direction and the desired speed.

The size, weight and efficiency of yokeless axial flux motors 500 enables multiple motors to be utilized in an automobile. According to one embodiment, separate motors may be included in the center of the automobile with one motor controlling each axel and wheel.

### BRIEF DESCRIPTION OF THE DRAWINGS

The features and advantages of the various embodiments will become apparent from the following detailed description in which:

FIG. 1 illustrates an example radial flux electric motor.

FIG. 2 illustrates an example axial flux electric motor.

FIG. 3 illustrates a cross-sectional view of an example axial flux electric motor.

FIG. 4 illustrates a cross-sectional view of an example yokeless axial flux electric motor.

FIG. 5 illustrates a cross-sectional view of an example axial flux yokeless motor.

FIG. 6 illustrates an electric automobile utilizing an inrunner axial flux yokeless electric motor (such as that illustrated in FIG. 5).

FIGS. 7A-D illustrate cross sectional views of various example outrunner axial flux yokeless motors mounted on a hollow non-rotating shaft, according to various embodiments.

FIGS. 8A-D illustrate cross sectional views of various example outrunner axial flux yokeless motors having a stator with a hollow shaft like protrusion, according to various embodiments.

FIGS. 9A-D illustrate cross sectional views of various example outrunner axial flux yokeless motors having a rotating shaft with a stator hollow shaft like protrusion, according to various embodiments.

FIG. 10 illustrates a cross-sectional view of an example outrunner axial flux yokeless outrunner motor being utilized in a wheel assembly, according to one embodiment.

FIG. 11 illustrates an example generator that could utilize the rotating shaft of an electric motor to generate electricity, according to one embodiment.

FIG. 12 illustrates an electric automobile utilizing an example outrunner axial flux yokeless outrunner motors and generators, according to one embodiment.

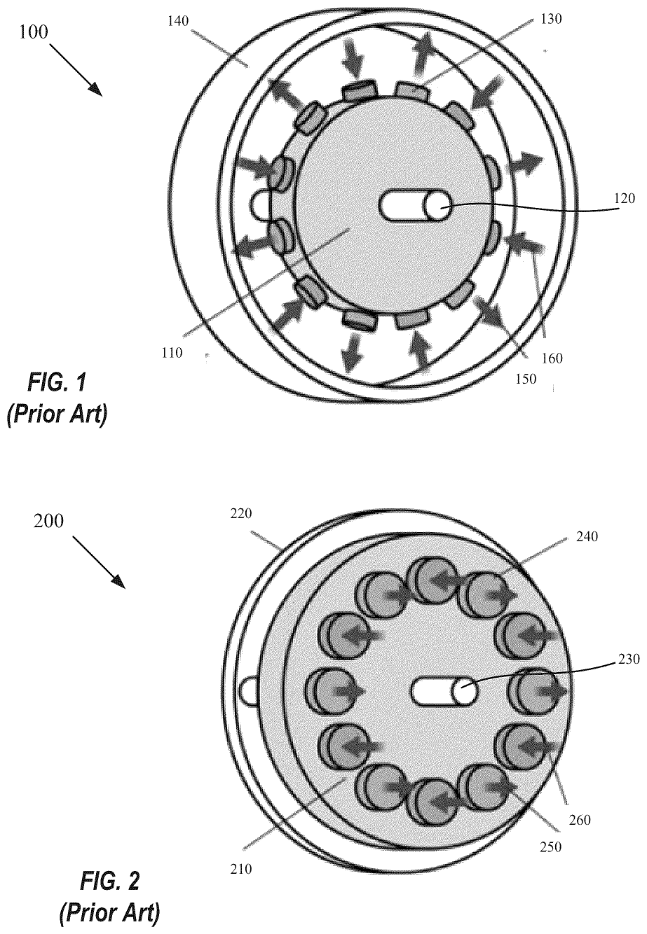

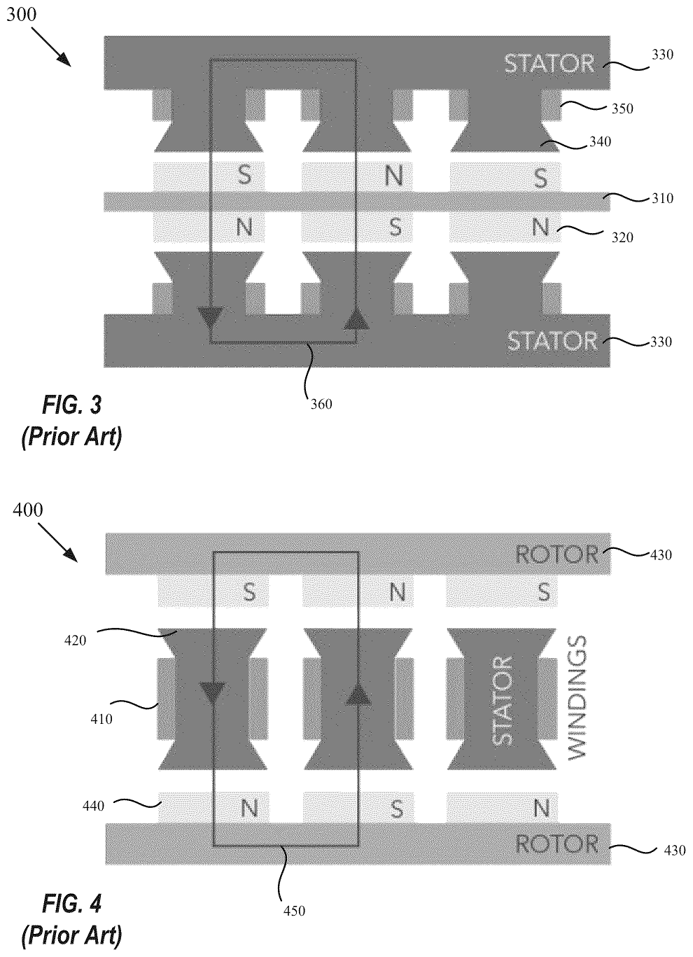

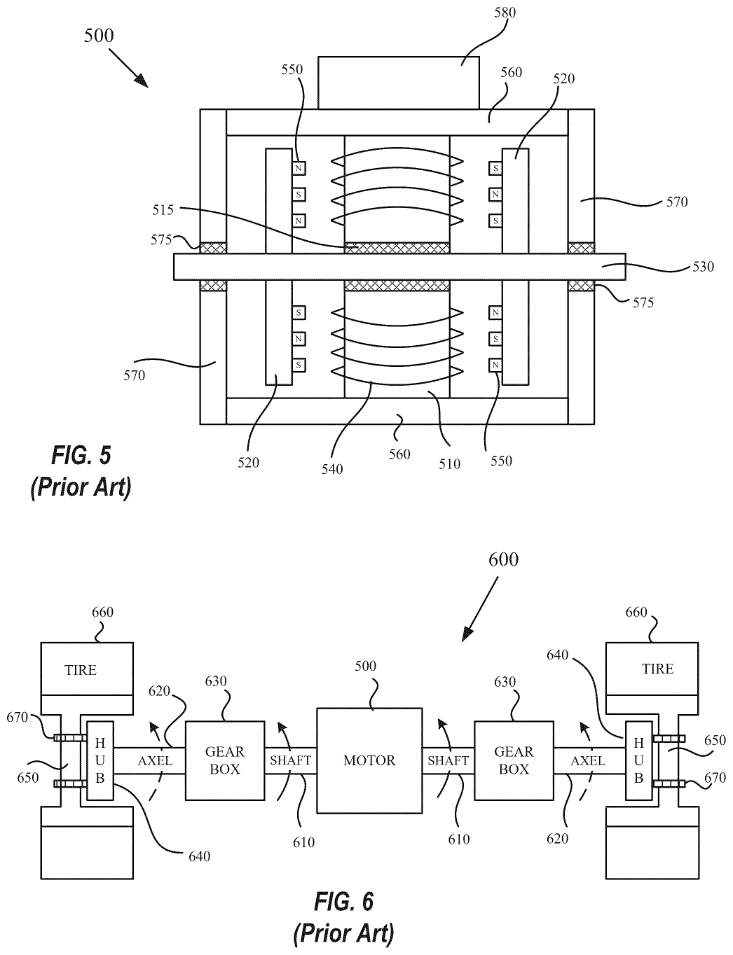

### DETAILED DESCRIPTION

Reducing the size of axial flux motors may enable the motors to be utilized within a wheel assembly so that each wheel is provided with its own motor. In such an arrangement, the rotors may be utilized to directly turn the wheel instead of utilizing the shaft and possibly a gear box. Utilizing the rotors to directly rotate the wheel, and not utilizing a gear box, means that the motor needs to operate at the desired speed as the speed is not altered by the gear box. A configuration that utilizes the rotors to turn the wheels is often referred to as outrunner since the rotors can be accessed external to the motor.

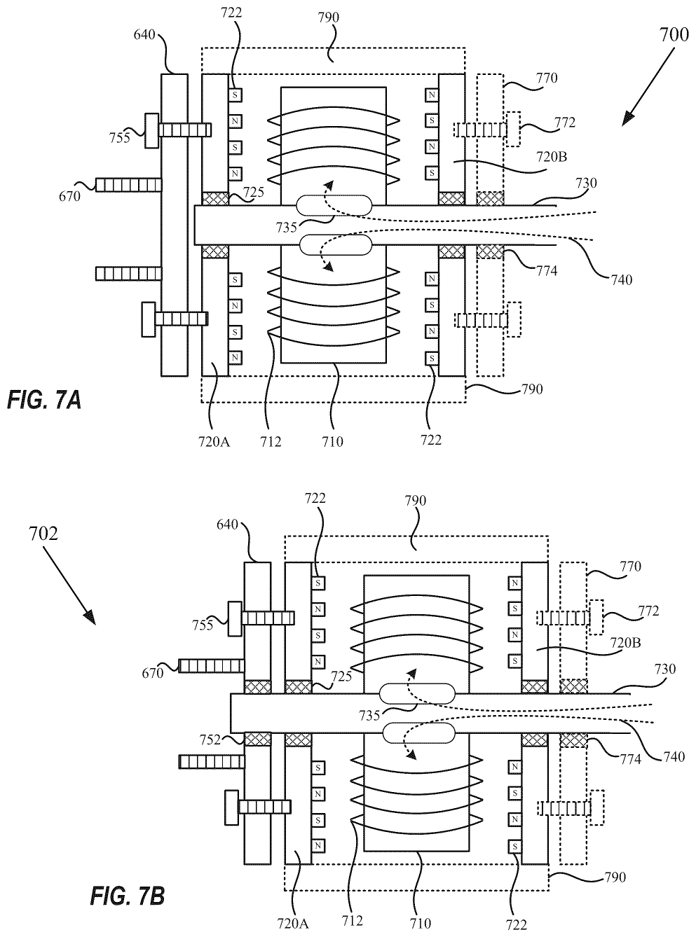

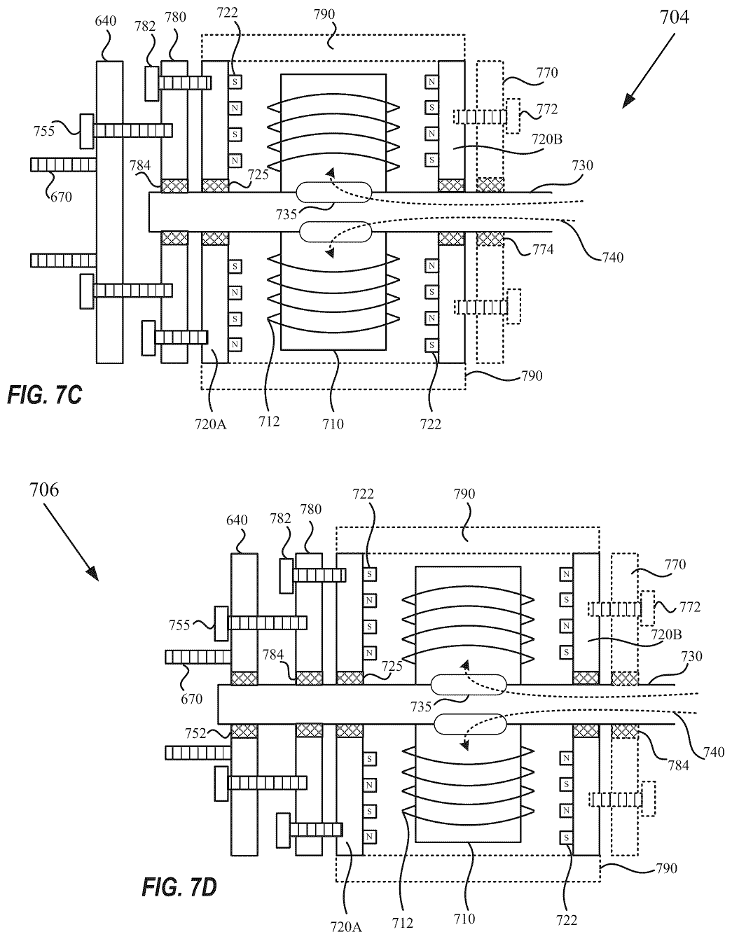

FIG. 7A illustrates a cross-sectional view of an example outrunner axial flux yokeless motor 700 mounted on a hollow non-rotating shaft. It should be noted that for ease of illustration, if there are multiple identical components included in a figure, not all of the components are separately identified (rather a single component or a subset of the components may simply be identified). The motor 700 includes a stator 710 and a pair of rotors 720A,B mounted on the hollow non-rotating shaft 730. The rotors 720A,B include bearings 725 so that when they rotate, they can rotate around the shaft 730 without moving the shaft 730. The stator 710 includes windings 712, and the rotors 720A,B include magnets 722 facing the stator 710. The polarity of the magnets 722 alternates on each rotor 720A,B and also between each rotor 720A,B. According to one embodiment, the rotors 720A,B may be slightly larger than the stator 710 so that the rotors 720A,B can be connected to one another with a connection means 790 (e.g., casing, rods) to ensure all the mechanical motion is available to be transferred. The connection means 790 is illustrated as connecting the tops and bottoms of the rotors 720A,B in cross sectional view, but is in no way intended to be limited thereto.

The use of the hollow non-rotating shaft 730 allows cables and cooling 740 to traverse therein. The stator 710 and the shaft 730 may have openings 735 in alignment with each other that enable the cables and cooling 740 to be received by the stator 710. Routing the cables and cooling 740 within the shaft 730 enables the size of the motor 700 to be reduced as one or more channels (e.g., 580) located external to the motor 700 (e.g., stator casing 560) are not required.

The hub 640 is mounted to the rotor 720A with, for example, bolts 755. However, the manner in which the hub 640 is secured to the rotor 720A is not limited thereto. The hub 640 includes bolts 670 extending therefrom in alignment with holes in a rim. The hub 640 is utilized to mount the rim of the wheel onto the vehicle. The hub 640 is illustrated as being mounted external to the shaft 730 so no bearings are needed. The size of the hub 640 is illustrated as being the same size as the rotor 720A but is not limited thereto.

According to one embodiment, the motor 700 may optionally include a plate (e.g., iron, steel) 770 mounted to the rotor 720B to provide support and/or protection for the motor (e.g., function as a housing). The size of the plate 770 is illustrated as being the same size as the rotor 720B but is not limited thereto. The plate 770 could be connected to the rotor 720B with, for example, bolts 772, but is not limited thereto. The plate 770 may be mounted to the shaft 730 utilizing bearings 774 so that the plate 770 can rotate around the shaft 730 with the rotor 720B.

FIGS. 7B-D illustrate cross sectional views of an example outrunner axial flux yokeless motors 702, 704, 706. The motors 702, 704, 706 are similar to the motor 700 so all the same reference numbers are used. FIG. 7B illustrates the motor 702 having the hub 640 mounted on the shaft 730 with bearings 752 so that it can rotate around the shaft 730 with the rotor 720A. FIG. 7C illustrates the motor 704 having a plate (e.g., iron, steel) 780 mounted to the rotor 720A and the hub 640 mounted to the plate 780 as opposed to the hub 640 being directly mounted to the rotor 720A. The plate 780 is to provide support and/or protection for the motor 704. The plate 780 is secured to the rotor 720A with, for example, bolts 782, and the hub 640 is secured to the plate 780 with, for example, bolts 755. The plate 780 may be mounted to the shaft 730 utilizing bearings 784 so that the plate 780 can rotate around the shaft 730 with the rotor 720A. FIG. 7D illustrates the motor 706 having the hub 640 mounted on the shaft 730 with bearings 752 so that it can rotate around the shaft 730 with the rotor 720A and plate 780.

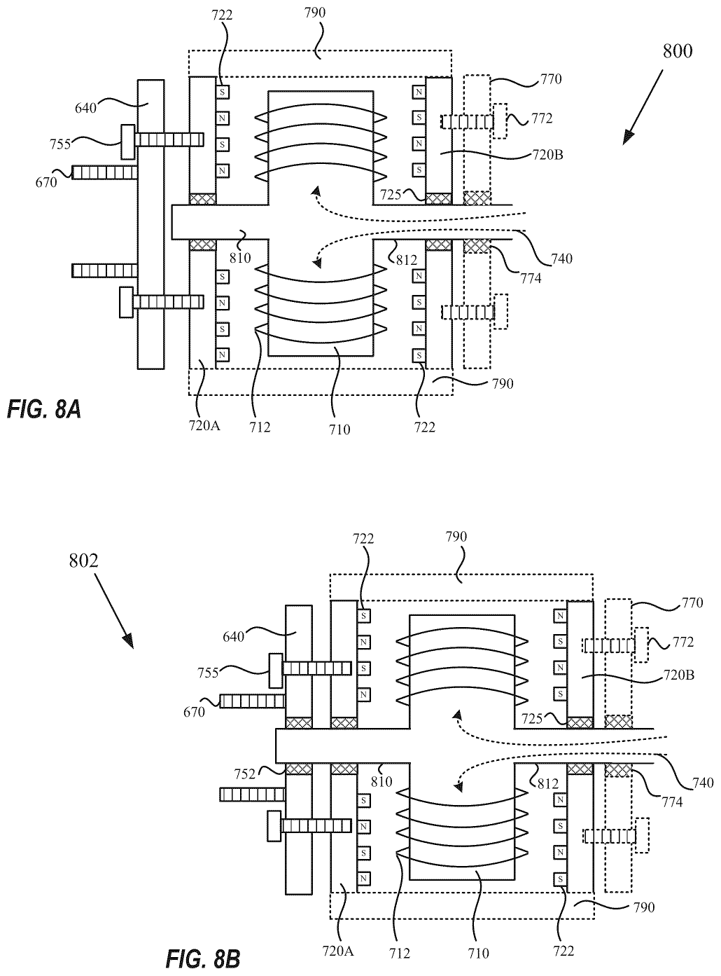

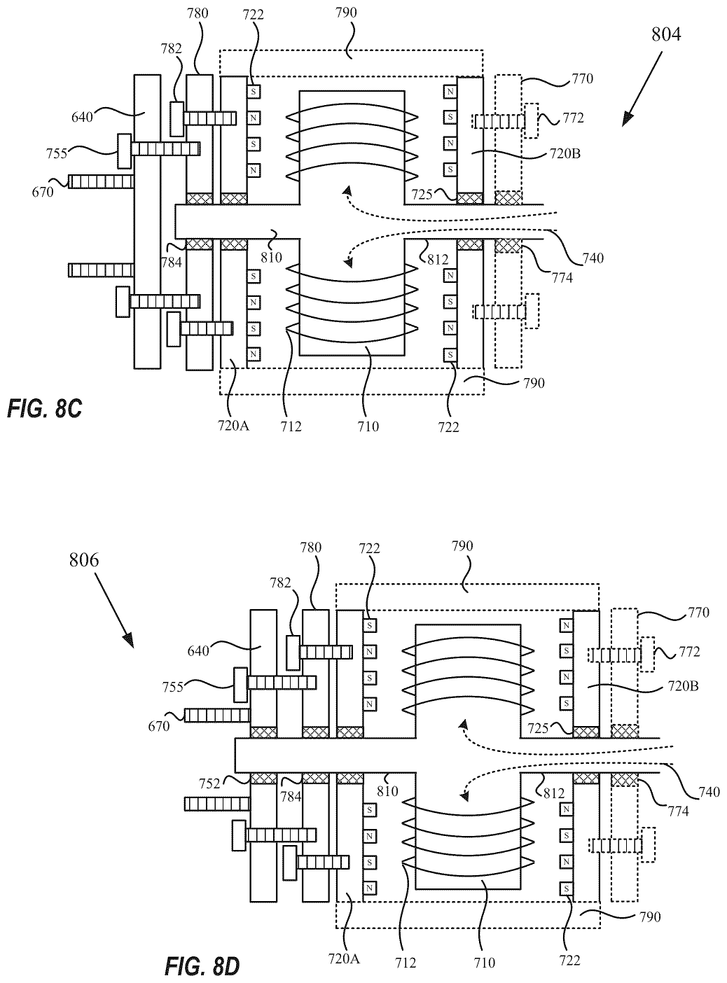

FIG. 8A illustrates a cross-sectional view of an example outrunner axial flux yokeless motor 800 having a stator 710 that includes a centrally located hollow shaft like protrusion extending therefrom. The motor 800 is similar to the motor 700 so the same reference numbers are used to identify the same parts. The shaft like protrusion includes a first end 810 extending in a first direction and a second end 812 extending in a second direction. The protrusion may be open to the stator 710. The first end 810 may be closed and the second end 812 is open so that the cables and cooling 740 can be received thereby. The rotors 720A,B may be mounted on the protrusion 810, 812 with bearings 725 to enable the rotors 720A,B to rotate therearound.

FIGS. 8B-D illustrate cross sectional views of an example outrunner axial flux yokeless motors 802, 804, 806. The motors 802, 804, 806 are similar to the motor 800 so all the same reference numbers are used. FIG. 8B illustrates the motor 802 having the hub 640 mounted on the protrusion 810 with bearings 752 so that it can rotate around the protrusion 810 with the rotor 720A. FIG. 8C illustrates the motor 804 having a plate (e.g., iron, steel) 780 mounted to the rotor 720A and the hub 640 mounted to the plate 780 as opposed to the hub 640 being directly mounted to the rotor 720A. FIG. 8D illustrates the motor 806 having the hub 640 mounted on the protrusion 810 with bearings 752 so that it can rotate around the protrusion 810 with the rotor 720A and plate 780.

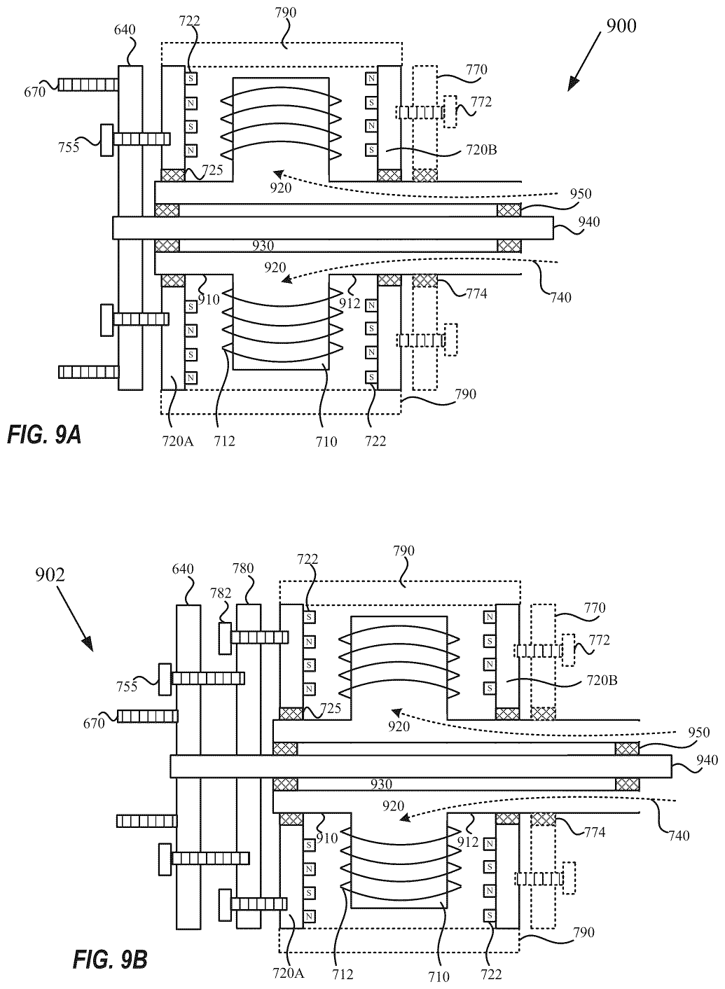

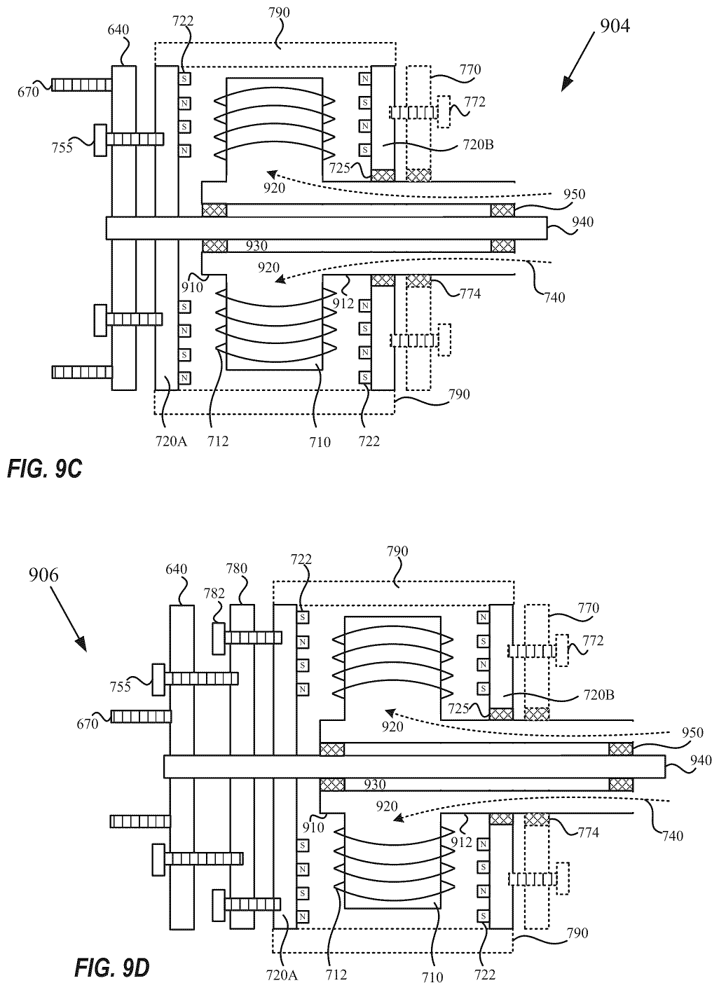

FIG. 9A illustrates a cross-sectional view of an example outrunner axial flux yokeless motor 900 having a rotating shaft 940 running through a centrally located shaft like protrusion extending from the stator 710. The motor 900 utilizes the same identification numbers for the same components as the other motors previously described. The shaft like protrusion includes a first end 910 extending in a first direction and a second end 912 extending in a second direction. The shaft like protrusion may include an outer chamber 920 and an inner chamber 930. The outer chamber 920 and the inner chamber 930 may be separated from one another. The outer chamber 920 is for routing the cables and cooling 740 while the inner chamber 930 is for receiving the shaft 940. Both the first end 910 and the second end 912 have an open inner chamber 930 to enable the rotating shaft 940 to pass therethrough. The second end 912 includes an open outer chamber 920 to receive the cables and cooling 740 while the outer chamber 920 of the first end 910 may be closed.

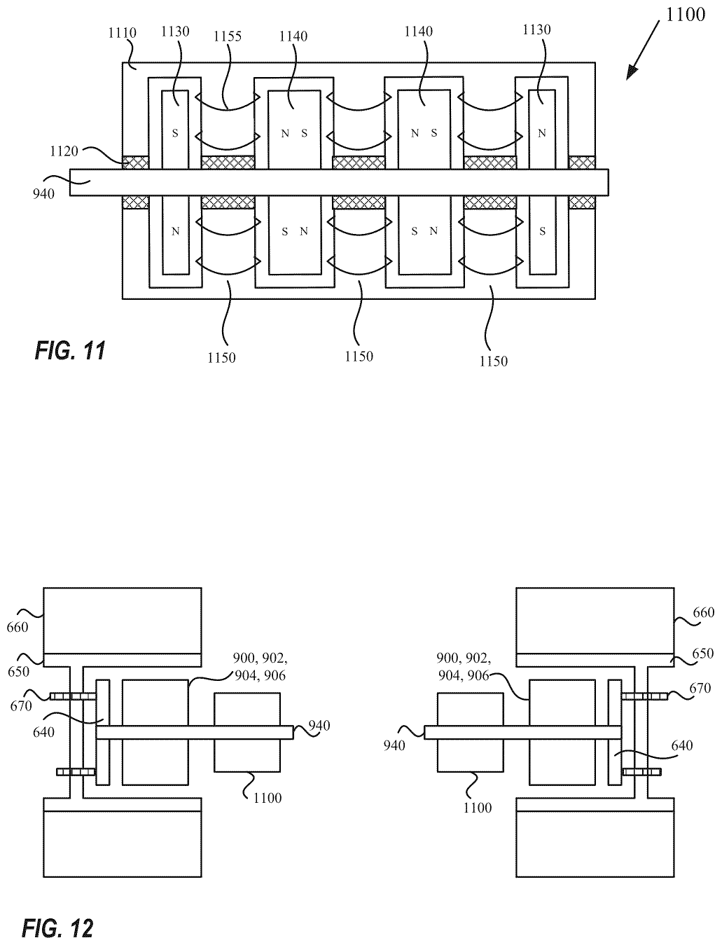

The protrusion 910, 912 is mounted on the shaft 940 with bearings 950 so that the shaft 940 can rotate within the stator 710 and shaft like protrusion 910, 912. The bearings 950 may be located on the interior portion 930. The rotors 720A,B are mounted to an exterior of the protrusion 910, 912 via bearings 725 so that they can rotate therearound. The optional plate 770 may be mounted to the exterior of the protrusion 910 via bearings 774. The hub 640 is mounted to the rotor 720A with, for example, bolts 755 and will rotate with the rotation of the rotor 720A. The hub 640 is directly to the shaft 940 (no bearings) so that the rotation of the hub 640 will result in the rotation of the shaft 940. The rotation of the shaft 940 can be utilized to, for example, generate power in a generator. The generator may be located external to the motor 900. For example, the motor 900 is located in the wheel well of the vehicle and the generator is located somewhere internal to the wheel well of the vehicle. An example generator will be discussed with respect to FIG. 11 and example location of the generator will be discussed with respect to FIG. 12.

FIGS. 9B-D illustrate cross sectional views of an example outrunner axial flux yokeless motors 902, 904, 906. The motors 902, 904, 906 are similar to the motor 900 so all the same reference numbers are used. FIG. 9B illustrates the motor 902 having a plate (e.g., iron, steel) 780 mounted to the rotor 720A and the hub 640 mounted to the plate 780 as opposed to the hub 640 being directly mounted to the rotor 720A. The plate 780 is also mounted directly to the shaft 940. The rotor 720A rotates the plate 780 and the hub 640 and the plate 780 and the hub 640 rotate the shaft 940. FIG. 9C illustrates the motor 904 where the rotor 720A is mounted on the shaft 940 directly instead of to the exterior of the protrusion 910 via bearings 725. As such, the rotation of the rotor 720A rotates the shaft 940 as well as the hub 640. FIG. 9D illustrates the motor 906 having the plate 780 mounted to the rotor 720A and the hub 640 mounted to the plate 780 as opposed to the hub 640 being directly mounted to the rotor 720A. The plate 780 is also mounted directly to the shaft 940. The rotor 720A rotates the shaft 940, the plate 780, and the hub 640.

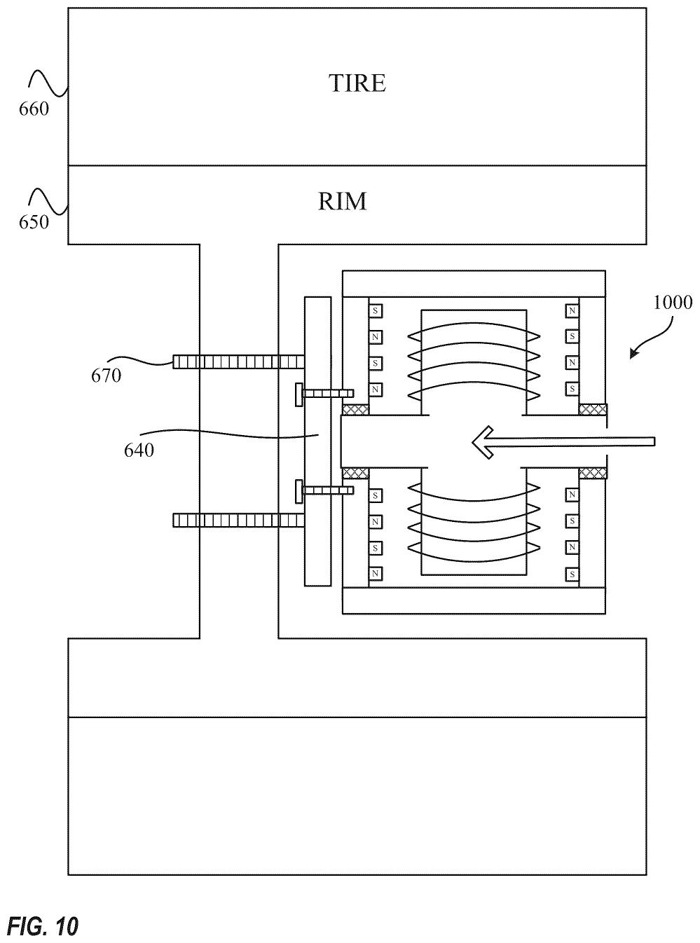

FIG. 10 illustrates a cross-sectional view of an example outrunner axial flux yokeless outrunner motor 1000 being utilized in a wheel assembly. The cables and the cooling 740 are provided within the motor footprint via some centrally located means (e.g., hollow shaft, hollow shaft like protrusion) that the rotors and stator are mounted on (secured to). According to one embodiment, the motor 1000 could be any of the motors discussed in any of the above FIGS. 7A-D, 8A-D and 9A-D.

FIG. 11 illustrates an example generator 1100 that could utilize the rotating shaft 940 to generate electricity. The generator 1100 includes a stator housing 1110 connected to the shaft 940 via bearings 1120 so that the stator housing 1110 does not rotate as the shaft 940 rotates. Within the stator housing 1110 there are alternating rotors 1130,1140 and stator cores 1150. The rotors 1130, 1140 include magnets (simply illustrated as S and N) and the stator cores 1150 include coils 1155. The rotors 1130, 1140 are secured to the shaft 940 and rotate with the shaft 940. The stator cores 1150 are connected to the shaft 940 via bearings 1120.

The rotors 1130 facing each end of the stator housing 1110 only have magnets on one side (side facing core 1150), while the rotors 1140 within the generator 1100 that has a core 1150 on each side thereof includes magnets on both sides of the rotor 1140. The polarity of the magnets on opposite sides of the rotor 1140 will be opposite. The rotation of the shaft 940 causes the rotors 1130, 1140 to rotate within the generator 1100. As the rotors 1130, 1140 rotate past the cores 1150 and the magnets past the coils 1155, the interaction between the magnets and the coils 1155 will generate electricity in the coils 1155. That is, as the alternating poles of magnets pass the coils 1155 it will cause current to flow in the coils 1155.

It should be noted that the generator 1100 was illustrated as including two rotors 1130, two rotors 1140 and three cores 1150, but is in no way intended to be limited thereto. Rather, the number of rotors 1130, 1140 and cores 1150 may vary without departing from the current scope. The number of 1130, 1140 and cores 1150 (and thus the length of the generator 710) may vary depending on, for example, the size (e.g., radius) of the rotors 1130, 1140 and cores 1150, the number and strength of the magnets, and the desired electric energy to be generated. Furthermore, the generator 1100 is not limited to the configuration illustrated. Rather, other axial or radial schemes of rotor and stator placement within a generator could be utilized without departing from the current scope.

FIG. 12 illustrates an electric automobile utilizing an example outrunner axial flux yokeless outrunner motors (e.g., 900, 902, 904, 906) and generators (e.g., 1100). The motors are located within the wheel wells of the vehicle and the generators are connected to the shaft extending therefrom internal to the wheel well of the vehicle. The motors turn the hub 640 which also turns the rim 650 and the tire 660 and causes the vehicle to move. The hub 640 (and possibly the rotors and/or plate) may also turn the shaft 940. The rotating shaft 940 causes the rotors with the generator to rotate and create electricity.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

1. An electric motor comprising:
a stator having a main body and a centrally located hollow protrusion extending therefrom, wherein the main body includes a plurality of windings, and wherein the stator remains stationary;
power cables and cooling to the stator routed through the centrally located hollow protrusion;
a shaft located within the centrally located hollow protrusion, wherein the stator is mounted to the shaft via bearings so the shaft can rotate therewithin;
a first rotor located on a first side of the stator having a plurality of magnets facing the stator, wherein the first rotor is to rotate when the stator is powered and direction of rotation is based on direction current flows through the coils;
a second rotor located on a second side of the stator having a plurality of magnets facing the stator, wherein the second rotor is to rotate when the stator is powered and direction of rotation is based on the direction current flows through the coils; and
a hub coupled to the first rotor, wherein the hub includes a plurality of bolts extending therefrom to mount a rim thereto by placing the bolts through aligned holes in the rim, wherein the hub is mounted to the shaft, and wherein the hub rotates with rotation of the first rotor and the rotation of the hub rotates the shaft.

2. The electric motor of claim 1, wherein the hub is secured to opposite side of the first rotor as the plurality of magnets.

3. The electric motor of claim 1, further comprising a first metal plate secured to opposite side of the first rotor as the plurality of magnets and mounted to the shaft, wherein the hub is secured to the first plate.

4. The electric motor of claim 1, further comprising a second metal plate secured to opposite side of the second rotor as the plurality of magnets.

5. The electric motor of claim 1, wherein the first rotor and the second rotor are mounted on the centrally located hollow protrusion with bearings so the first rotor and the second rotor can rotate around the centrally located hollow protrusion.

6. The electric motor of claim 1, wherein the first rotor is mounted on the shaft and the second rotor is mounted on the centrally located hollow protrusion with bearings, wherein rotation of the first rotor will rotate the shaft and the second rotor can rotate around the centrally located hollow protrusion.

7. The electric motor of claim 1, wherein the centrally located hollow protrusion includes an outer chamber for routing the power cables and cooling and an inner chamber for the shaft to pass through.

8. The electric motor of claim 1, wherein the motor is mounted in a wheel assembly of an electric automobile.

9. The electric motor of claim 1, wherein the rotation of the shaft is utilized by a generator to generate electricity.

10. The electric motor of claim 9, wherein the generator is located on the shaft on opposite side of the second rotor as the plurality of magnets.

11. An electric motor comprising:
a stator having a main body and a centrally located hollow protrusion extending therefrom, wherein the main body includes a plurality of windings, and wherein the stator includes an inner chamber and an outer chamber;
power cables and cooling to the stator routed through the outer chamber of the centrally located hollow protrusion;
a shaft located within the inner chamber of the centrally located hollow protrusion, wherein the inner chamber of the centrally located hollow protrusion is mounted to the shaft via bearings so the shaft can rotate therewithin;
a first rotor mounted on an exterior of a first side of the centrally located hollow protrusion and having a plurality of magnets facing the stator;
a second rotor located on an exterior of a second side of the centrally located hollow protrusion and having a plurality of magnets facing the stator, wherein the first rotor and the second rotor are to rotate around the centrally located hollow protrusion when the stator is powered and direction of rotation is based on direction current flows through the coils; and
a hub coupled to the first rotor, wherein the hub includes a plurality of bolts extending therefrom to mount a rim thereto by placing the bolts through aligned holes in the rim, wherein the hub is mounted to the shaft, and wherein the hub rotates with rotation of the first rotor and the rotation of the hub rotates the shaft.

12. The electric motor of claim 11, wherein the hub is secured to opposite side of the first rotor as the plurality of magnets.

13. The electric motor of claim 11, further comprising a first metal plate secured to opposite side of the first rotor as the plurality of magnets and mounted to the shaft, wherein the hub is secured to the first plate.

14. The electric motor of claim 11, further comprising a second metal plate secured to opposite side of the second rotor as the plurality of magnets.

15. The electric motor of claim 11, wherein the motor is mounted in a wheel assembly of an electric automobile.

16. The electric motor of claim 11, wherein the rotation of the shaft is utilized by a generator to generate electricity.

17. The electric motor of claim 16, wherein the generator is located on the shaft on opposite side of the second rotor as the plurality of magnets.

18. An electric automobile comprising
a chassis;
a plurality of wheel assemblies to receive a plurality of rims and an associated plurality of tires mounted to the rims; and
a plurality of electric motors, wherein an electric motor is housed within each of the plurality of wheel assemblies, wherein the electric motors include:
a stator having a main body and a centrally located hollow protrusion extending therefrom, wherein the main body includes a plurality of windings;
power cables and cooling to the stator routed through the centrally located hollow protrusion;
a shaft located within the centrally located hollow protrusion, wherein the stator is mounted to the shaft via bearings so the shaft can rotate therewithin;
a first rotor mounted on an exterior of a first side of the centrally located hollow protrusion and having a plurality of magnets facing the stator;
a second rotor located on an exterior of a second side of the centrally located hollow protrusion and having a plurality of magnets facing the stator, wherein the first rotor and the second rotor are to rotate around the centrally located hollow protrusion when the stator is powered and direction of rotation is based on direction current flows through the coils;
a hub coupled to the first rotor, wherein the hub includes a plurality of bolts extending therefrom to mount a rim thereto by placing the bolts through aligned holes in the rim, wherein the hub is mounted to the shaft, and wherein the hub rotates with rotation of the first rotor and the rotation of the hub rotates the shaft.

19. The electric automobile of claim 18, further comprising a plurality of generators, wherein a generator is connected to the shaft from each of the plurality of electric motors.

20. The electric automobile of claim 19, wherein the plurality of generators are located on opposite side of the second rotor as the plurality of magnets and internal to the wheel assemblies.
